(19) United States
(12) Patent Application Publication
(10) Pub. No.: US 2025/0217929 A1
(43) Pub. Date: Jul. 3, 2025

(54) METHOD AND SYSTEM FOR MULTIMODAL IMAGE SUPER-RESOLUTION USING CONVOLUTIONAL DICTIONARY LEARNING

(71) Applicant: Tata Consultancy Services Limited, Mumbai (IN)

(72) Inventors: Kriti KUMAR, Bangalore (IN); Achanna Anil KUMAR, Bangalore (IN); Mariswamy Girish CHANDRA, Bangalore (IN); Saurabh SAHU, Bangalore (IN); Angshul MAJUMDAR, New Delhi (IN)

(73) Assignee: Tata Consultancy Services Limited, Mumbai (IN)

(21) Appl. No.: 18/986,927

(22) Filed: Dec. 19, 2024

(30) Foreign Application Priority Data
Dec. 29, 2023 (IN) 202321089711

(51) Int. Cl. G06T 3/4076; G06T 3/4046; G06T 5/60; G06T 11/00

(52) U.S. Cl. CPC G06T 3/4076; G06T 3/4046; G06T 5/60; G06T 11/00; G06T 2207/20016; G06T 2207/20081; G06T 2207/20084; G06T 2210/36

(57) ABSTRACT

This disclosure relates generally to the field of image processing, and, more particularly, to a method and system for Multimodal Image Super-Resolution (MISR) using convolutional dictionary learning. Existing sparse representation learning based techniques for MISR have certain limitations which impact quality of the reconstructed image. The present disclosure performs MISR using convolutional dictionaries which are translation invariant. Low-resolution image of the target modality and high-resolution image of the guidance modality are modelled using their respective convolutional dictionaries and associated coefficients. Additionally, two coupling convolutional dictionaries are learned to model the relationship between them and synthesize the high-resolution image of the target modality more efficiently.

### PRIORITY CLAIM

This U.S. patent application claims priority under 35 U.S.C. § 119 to: Indian Patent Application number 202321089711, filed on Dec. 29, 2023. The entire contents of the aforementioned application are incorporated herein by reference.

### TECHNICAL FIELD

The disclosure herein generally relates to the field of image processing, and, more particularly, to a method and system for multimodal image super-resolution using convolutional dictionary learning.

### BACKGROUND

Image super-resolution (ISR) refers to enhancing pixel-based image resolution by minimizing visual artifacts. Generating a high-resolution (HR) version of a low-resolution (LR) image is a complex task that involves inferring missing pixel values, which makes ISR a challenging and ill-posed problem. Different approaches have been proposed to regularize this ill-posed problem by incorporating prior knowledge, such as natural priors, local and non-local similarity, features based on dictionary learning and deep learning. But all these methods primarily focus on single-modality images without exploiting the information available from other imaging modalities that can be utilized as guidance for ISR. In many practical applications with multi-modal imaging systems in place, the same scene is captured by different imaging modalities. Remote sensing for earth observation is one such application where panchromatic, multi-spectral images are acquired at different resolutions to manage the cost, bandwidth, and complexity. This drives the need for Multi-modal Image Super-Resolution (MISR) techniques that can enhance the LR images of the target modality using the information from HR images of other modalities (referred as guidance modality) that share salient features like boundaries, textures, edges, etc. Depth map super-resolution with guidance from RGB, medical image super-resolution using multi-modal Magnetic Resonance (MR) and cross-modal Computed Tomography (CT) and MR image are some other applications where MISR is required.

Existing works in the field of MISR include compressive sensing, Guided image Filtering (GF), Joint Bilateral Filtering (JBF), Joint image Restoration (JR), Deep Joint image Filtering (DJF), Coupled Dictionary Learning (Coupled DL), Joint Coupled Transform Learning (JCTL) and Joint Coupled Deep Transform Learning (JCDTL), and the recent Multi-modal Convolutional Dictionary Learning technique (MCDL). All these techniques differ in the way they transfer the structural details of the guidance image to enhance the LR image of target modality. Their performance depends on how well they are able to identify and model the complex dependencies between the two imaging modalities. Sparse representation learning using Dictionary Learning (DL) has gained popularity for addressing inverse problems including MISR but it has certain constraints. One notable limitation is that the learned dictionaries are inherently not translation invariant, i.e., the basis elements often appear as shifted versions of one another. Additionally, as these dictionaries operate on individual patches rather than the entire image, they reconstruct and sparsify patches independently, due to which the underlying structure of the signal may get lost. Both these limitations impact quality of the reconstructed image. Convolutional Dictionary Learning (CDL), on the other hand, employs translation-invariant dictionaries, called convolutional dictionaries, which can effectively mitigate these limitations. These dictionaries are well-suited for representing signals that exhibit translation invariance, such as natural images and sounds, making them applicable to a range of image processing and computer vision tasks.

Some of the works in literature have attempted usage of CDL for MISR but they have certain drawbacks. One such work discloses an image super-resolution analysis method based on multi-modal convolution sparse coding network which comprises of learning 5 modules (1 multi-modal convolutional sparse encoder, 2 side information encoders and 2 convolutional decoders) to generate a HR image of target modality. This network has a large number of parameters that has to be trained and therefore requires huge amount of training data and longer training time.

### SUMMARY

Embodiments of the present disclosure present technological improvements as solutions to one or more of the above-mentioned technical problems recognized by the inventors in conventional systems. For example, in one embodiment, a method for multimodal image super-resolution using convolutional dictionary learning is provided. The method includes obtaining a plurality of training images comprising a set of low-resolution images ‘X’ of a target modality, a set of high-resolution images ‘Y’ of a guidance modality, and a set of high-resolution images ‘Z’ of the target modality. Further, the method includes initializing a plurality of dictionaries and associated plurality of sparse coefficients. The plurality of dictionaries comprise i) a first convolutional dictionary ‘S’ associated with a first set of sparse coefficients ‘A’ among the plurality of sparse coefficients, ii) a second convolutional dictionary ‘G’ associated with a second set of sparse coefficients ‘B’ among the plurality of sparse coefficients, iii) a first coupling convolutional dictionary ‘W’, and iv) a second coupling convolutional dictionary ‘V’. Furthermore, the method includes jointly training the initialized plurality of dictionaries and the associated plurality of sparse coefficients using the plurality of training images by performing a plurality of steps iteratively until convergence of an objective function is achieved. The plurality of steps comprise training the plurality of sparse coefficients by keeping the plurality of dictionaries fixed; and training the plurality of dictionaries by keeping the plurality of sparse coefficients fixed. The trained plurality of dictionaries and the associated plurality of sparse coefficients obtained upon achieving the convergence of the objective function are used for performing a multimodal image super resolution.

In another aspect, a system for multimodal image super-resolution using convolutional dictionary learning is provided. The system includes: a memory storing instructions; one or more communication interfaces; and one or more hardware processors coupled to the memory via the one or more communication interfaces, wherein the one or more hardware processors are configured by the instructions to obtain a plurality of training images comprising a set of low-resolution images ‘X’ of a target modality, a set of high-resolution images ‘Y’ of a guidance modality, and a set of high-resolution images ‘Z’ of the target modality. Further, the one or more hardware processors are configured by the instructions to initialize a plurality of dictionaries and associated plurality of sparse coefficients. The plurality of dictionaries comprise i) a first convolutional dictionary ‘S’ associated with a first set of sparse coefficients ‘A’ among the plurality of sparse coefficients, ii) a second convolutional dictionary ‘G’ associated with a second set of sparse coefficients ‘B’ among the plurality of sparse coefficients, iii) a first coupling convolutional dictionary ‘W’, and iv) a second coupling convolutional dictionary ‘V’. Furthermore, the one or more hardware processors are configured by the instructions to jointly train the initialized plurality of dictionaries and the associated plurality of sparse coefficients using the plurality of training images by performing a plurality of steps iteratively until convergence of an objective function is achieved. The plurality of steps comprise training the plurality of sparse coefficients by keeping the plurality of dictionaries fixed; and training the plurality of dictionaries by keeping the plurality of sparse coefficients fixed. The trained plurality of dictionaries and the associated plurality of sparse coefficients obtained upon achieving the convergence of the objective function are used for performing a multimodal image super resolution.

In yet another aspect, there are provided one or more non-transitory machine-readable information storage mediums comprising one or more instructions which when executed by one or more hardware processors cause a method for multimodal image super-resolution using convolutional dictionary learning. The method includes obtaining a plurality of training images comprising a set of low-resolution images ‘X’ of a target modality, a set of high-resolution images ‘Y’ of a guidance modality, and a set of high-resolution images ‘Z’ of the target modality. Further, the method includes initializing a plurality of dictionaries and associated plurality of sparse coefficients. The plurality of dictionaries comprise i) a first convolutional dictionary ‘S’ associated with a first set of sparse coefficients ‘A’ among the plurality of sparse coefficients, ii) a second convolutional dictionary ‘G’ associated with a second set of sparse coefficients ‘B’ among the plurality of sparse coefficients, iii) a first coupling convolutional dictionary ‘W’, and iv) a second coupling convolutional dictionary ‘V’. Furthermore, the method includes jointly training the initialized plurality of dictionaries and the associated plurality of sparse coefficients using the plurality of training images by performing a plurality of steps iteratively until convergence of an objective function is achieved. The plurality of steps comprise training the plurality of sparse coefficients by keeping the plurality of dictionaries fixed; and training the plurality of dictionaries by keeping the plurality of sparse coefficients fixed. The trained plurality of dictionaries and the associated plurality of sparse coefficients obtained upon achieving the convergence of the objective function are used for performing a multimodal image super resolution.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles:

FIG. 1 illustrates an exemplary system for multimodal image super-resolution using convolutional dictionary learning, according to some embodiments of the present disclosure.

FIG. 2 illustrates a flow diagram of a processor implemented method for multimodal image super-resolution using convolutional dictionary learning, according to some embodiments of the present disclosure.

FIG. 3 is a block diagram of an example implementation of method of FIG. 2, according to some embodiments of the present disclosure.

FIG. 4 illustrates convergence plot of an example implementation of method of FIG. 2, according to some embodiments of the present disclosure.

FIGS. 5A to 5D, collectively referred as FIG. 5, illustrate examples of trained plurality of dictionaries obtained from method of FIG. 2, according to some embodiments of the present disclosure.

### DETAILED DESCRIPTION

Exemplary embodiments are described with reference to the accompanying drawings. In the figures, the left-most digit(s) of a reference number identifies the figure in which the reference number first appears. Wherever convenient, the same reference numbers are used throughout the drawings to refer to the same or like parts. While examples and features of disclosed principles are described herein, modifications, adaptations, and other implementations are possible without departing from the scope of the disclosed embodiments.

In multi-modal imaging systems, different modalities often capture the image from the same scene. While different sensors contain unique features, they still share some common features, for example, edges, texture, and shapes, that can be leveraged for super-resolution tasks. The objective of Multi-modal Image Super resolution (MISR) is to reconstruct a High Resolution (HR) image z of target modality from a Low Resolution (LR) image x of target modality with the guidance of HR image y from another modality, referred as guidance modality, by modelling the cross-modal dependencies between the different modalities. The existing techniques of MISR differ in the way they transfer the structural details of the guidance image to enhance the LR image of target modality. Their performance depends on how well they are able to identify and model the complex dependencies between the two imaging modalities. To handle the disparities between the guidance and target modality much better, learning-based methods like deep learning, and sparse representation learning employing dictionaries and transforms are more popular. In general, deep learning methods require more training data and massive compute resources for good reconstruction. Also, they lack interpretability and the trained models are not guaranteed to enforce measurement consistency between the inputs and the output during testing. In contrast, sparse representation learning-based methods do not suffer from these drawbacks and offer an improved performance compared to deep learning techniques, especially with limited training data.

However, sparse representation learning based techniques also have certain constraints. The learned dictionaries are inherently not translation invariant. Additionally, as these dictionaries operate on individual patches rather than the entire image, they reconstruct and sparsify patches independently, due to which the underlying structure of the signal may get lost. Both these limitations impact the quality of the reconstructed image. Thus, the present disclosure provides a method and system for multi-modal image super resolution using convolutional dictionaries which are translation invariant. The convolutional dictionaries consists of a set of M filters and associated sparse coefficients that are learned to capture features (such as edges, corners, color gradients, boundaries etc.) of input images from different modalities. As understood by a person skilled in the art, in convolutional dictionary learning, a signal (i.e. image, in the context of present disclosure) {xᵢ}ᵢ₌₁^{N} with N measurements each of n dimension is reconstructed using a set of M linear filters {dₘ}ₘ₌₁^{M} and associated set of coefficients {a_{m,i}}ₘ₌₁^{M} by optimizing equation 1.

$${min}_{\{ {d}_{m} \} , \{ {a}_{m , i} \}} \frac{1}{2} {\sum }_{i = 1}^{N} {‖ {x}_{i} - {\sum }_{m = 1}^{M} {d}_{m} * {a}_{m , i} ‖}_{2}^{2} + {\sum }_{i , m} {‖ {a}_{m , i} ‖}_{1} , subject to {‖ {d}_{m} ‖}_{2}^{2} = 1 ∀ m \qquad ( 1 )$$

In equation 1, * denotes convolution operation, l₁ norm on a_{m,i} is used to enforce sparsity and l₂ norm constraint on dₘ is employed to compensate for scaling ambiguity between dictionary atoms and the coefficients. Defining Dₘ as a linear operator such that Dₘa_{m,i}=dₘ*a_{m,i} and taking D=(D₁, . . . , Dₘ), X=(x₁, . . . , x_{N}) and

$$A = ( \begin{matrix}{a}_{1 , 1} & ⋯ & {a}_{1 , N} \\ ⋮ & ⋮ & ⋮ \\ {a}_{M , 1} & ⋯ & {a}_{M , N}\end{matrix} ) ,$$

equation 1 is rewritten as equation 2.

$${min}_{D , A} \frac{1}{2} {‖ X - DA ‖}_{F}^{2} + λ {‖ A ‖}_{1} \qquad ( 2 )$$

The optimization problem in equation 2 is not jointly convex in both the dictionary filters and the coefficients. Hence, Alternating Minimization (AM) technique is employed to estimate them. While the convolutional sparse coefficients can be solved by Alternating Direction Method of Multipliers (ADMM) in the DFT domain, the convolutional dictionaries can be solved using the Convolutional Constrained Method of Optimal Directions (CCMOD).

Embodiments of present disclosure provide a method and system for multi-modal image super resolution using convolutional dictionaries. Initially a plurality of training images are obtained. The plurality of training images comprise a set of low-resolution (LR) images ‘X’ of a target modality, a set of high-resolution (HR) images ‘Y’ of a guidance modality, and a set of high-resolution (HR) images ‘Z’ of the target modality. Then, a plurality of dictionaries and associated plurality of sparse coefficients are initialized. The plurality of dictionaries comprise i) a first convolutional dictionary ‘S’ associated with a first set of sparse coefficients ‘A’ among the plurality of sparse coefficients. The first convolutional dictionary comprises M filters to extract features from the set of low-resolution images of the target modality; ii) a second convolutional dictionary ‘G’ associated with a second set of sparse coefficients ‘B’ among the plurality of sparse coefficients. The second convolutional dictionary comprises M filters to extract features from the set of high-resolution images of the guidance modality; iii) a first coupling convolutional dictionary ‘W’; and iv) a second coupling convolutional dictionary ‘V’. The first and second coupling convolutional dictionaries model the relationship between the target and guidance modalities. Initializing the dictionaries and coefficients provides a starting point for the training process. The initialized plurality of dictionaries and associated plurality of sparse coefficients are jointly trained (updated) iteratively using the plurality of training images until convergence of an objective function is achieved. At each iteration, the sparse coefficients are trained by keeping dictionaries fixed and then the dictionaries are trained by keeping sparse coefficients fixed. The trained plurality of dictionaries and the associated plurality of sparse coefficients obtained upon achieving the convergence of the objective function are used for performing multimodal image super resolution.

When a new low-resolution image of the target modality and a high resolution image of guidance modality are obtained, the plurality of sparse coefficients are computed based on the trained plurality of dictionaries and the obtained images. A first set of coefficients A is computed based on the trained first convolutional dictionary S and the low-resolution image of the target modality by using a standard convolutional sparse coding update. Similarly, a second set of coefficients B is computed based on the trained second convolutional dictionary S and the low-resolution image of the target modality by using a standard convolutional sparse coding update. Then, a high resolution image Z^{test} of the target modality is generated using the trained first coupling convolutional dictionary, the trained second coupling convolutional dictionary, the first set of test coefficients, and the second set of test coefficients as Z^{test}=WA+VB.

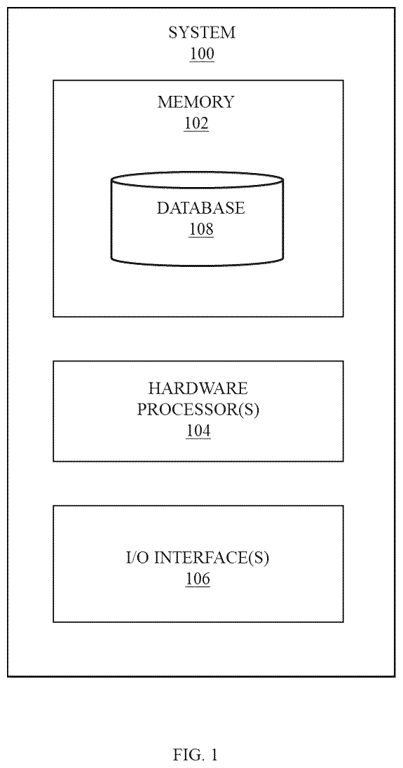

Referring now to the drawings, and more particularly to FIG. 1 through 5, where similar reference characters denote corresponding features consistently throughout the figures, there are shown preferred embodiments and these embodiments are described in the context of the following exemplary system and/or method.

FIG. 1 illustrates an exemplary system for multimodal image super-resolution using convolutional dictionary learning, according to some embodiments of the present disclosure. In an embodiment, the system 100 includes one or more processors (104), communication interface device(s) (106) or Input/Output (I/O) interface(s) (106) or user interface (106), and one or more data storage devices or memory (102) operatively coupled to the one or more processors (104). The one or more processors (104) that are hardware processors can be implemented as one or more microprocessors, microcomputers, microcontrollers, digital signal processors, central processing units, state machines, logic circuitries, and/or any devices that manipulate signals based on operational instructions. Among other capabilities, the processor(s) is configured to fetch and execute computer-readable instructions stored in the memory. In an embodiment, the system 100 can be implemented in a variety of computing systems, such as laptop computers, notebooks, hand-held devices, workstations, mainframe computers, servers, a network cloud, and the like.

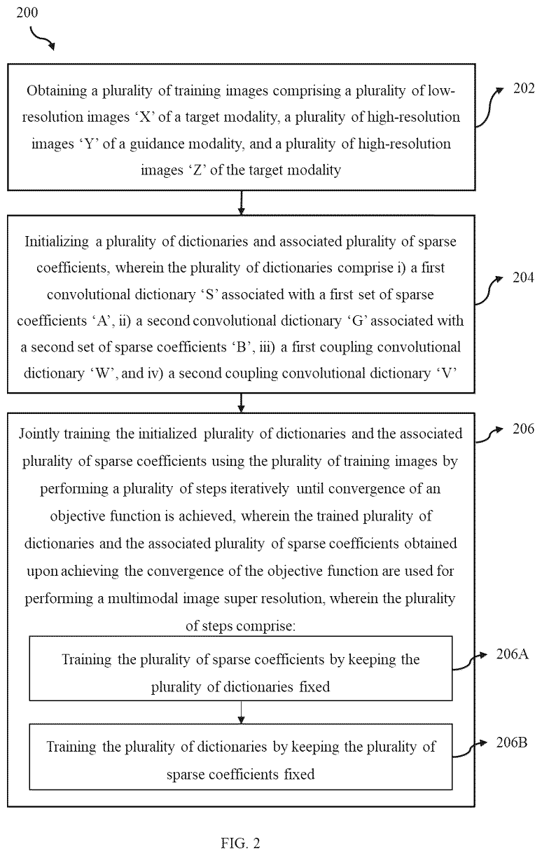

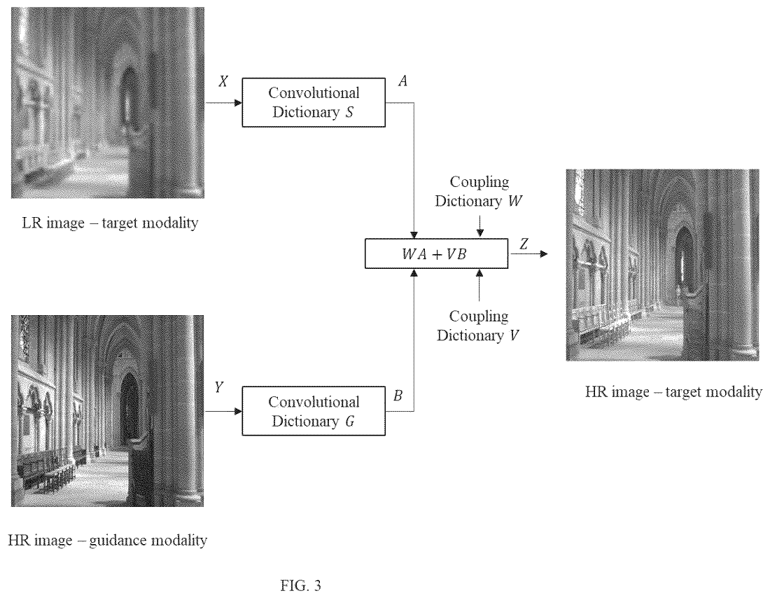

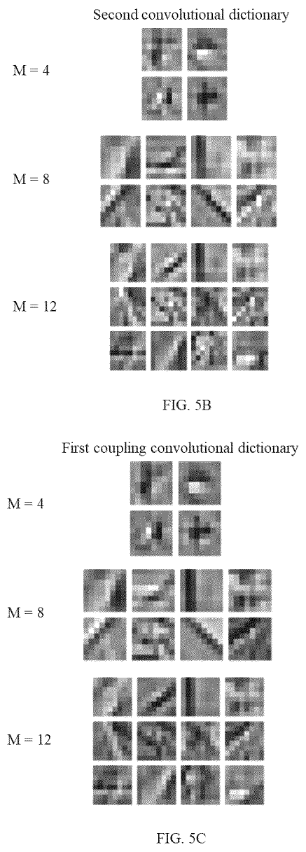

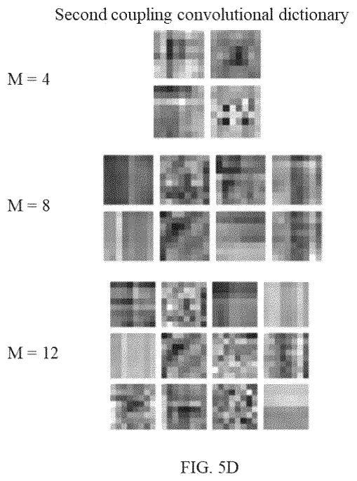

The I/O interface device(s) (106) can include a variety of software and hardware interfaces, for example, a web interface, a graphical user interface, and the like and can facilitate multiple communications within a wide variety of networks and protocol types, including wired networks, for example, LAN, cable, etc., and wireless networks, such as WLAN, cellular, or satellite. In an embodiment, the I/O interface device(s) (106) receives low resolution image of target modality and high resolution image of guidance modality as input and provides high resolution image of target modality as output. The memory (102) may include any computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. Functions of the components of system 100 are explained in conjunction with flow diagram depicted in FIG. 2 and examples illustrated in FIGS. 3 and 5 for multimodal image super-resolution using convolutional dictionary learning.

In an embodiment, the system 100 comprises one or more data storage devices or the memory (102) operatively coupled to the processor(s) (104) and is configured to store instructions for execution of steps of the method (200) depicted in FIG. 2 by the processor(s) or one or more hardware processors (104). The steps of the method of the present disclosure will now be explained with reference to the components or blocks of the system 100 as depicted in FIG. 1, the steps of flow diagrams as depicted in FIG. 2, and examples illustrated in FIGS. 3 and 5. Although process steps, method steps, techniques or the like may be described in a sequential order, such processes, methods, and techniques may be configured to work in alternate orders. In other words, any sequence or order of steps that may be described does not necessarily indicate a requirement that the steps to be performed in that order. The steps of processes described herein may be performed in any order practical. Further, some steps may be performed simultaneously.

FIG. 2 illustrates a flow diagram of a processor implemented method (200) for multimodal image super-resolution using convolutional dictionary learning, according to some embodiments of the present disclosure. At step 202 of the method 200, the one or more hardware processors are configured to obtain a plurality of training images (i=1, 2, . . . , N training images) comprising a set of LR images ‘X’ of a target modality, a set of HR images ‘Y’ of a guidance modality, and a set of HR images ‘Z’ of the target modality. For example, the target modality is NIR (Near InfraRed) or MS (Multispectral) and guidance modality is RGB. Further, at step 204 of the method 200, the one or more hardware processors are configured to initialize a plurality of dictionaries and associated plurality of sparse coefficients. The plurality of dictionaries have M filters each to extract features from images of different modalities. The plurality of dictionaries comprise i) a first convolutional dictionary ‘S’ (mathematically represented as {sₘ}ₘ₌₁^{M}) associated with a first set of sparse coefficients ‘A’ ({a_{m,i}}ₘ₌₁^{M}), ii) a second convolutional dictionary ‘G’ ({gₘ}ₘ₌₁^{M}) associated with a second set of sparse coefficients ‘B’ ({b_{m,i}}ₘ₌₁^{M}), iii) a first coupling convolutional dictionary ‘W’ ({wₘ}ₘ₌₁^{M}), and iv) a second coupling convolutional dictionary ‘V’ ({vₘ}ₘ₌₁^{M}). Initializing the dictionaries and coefficients provides a starting point for training process. In an embodiment, all the dictionary filters are initialized with a random matrix with real numbers between 0 and 1 drawn from a uniform distribution. The coefficients are initialized with a matrix with 0's. Different initialization techniques may be used in alternate embodiments. The first convolutional dictionary comprises M filters to extract features from low-resolution images of the target modality. The second convolutional dictionary comprises M filters to extract features from the high-resolution images of the guidance modality. The first coupling convolutional dictionary and the second coupling convolutional dictionary are used to model relationship between the target and guidance modalities i.e., between the first set of sparse coefficients and the second set of sparse coefficients such that equation 3 is satisfied. In equation 3, zᵢ is an image from the set of HR images ‘Z’ of the target modality.

$${z}_{i} = {\sum }_{m = 1}^{M} {w}_{m} * {a}_{m , i} + {\sum }_{m = 1}^{M} {v}_{m} * {b}_{m , i} \qquad ( 3 )$$

Once the plurality of dictionaries and associated plurality of sparse coefficients are initialized, at step 206 of the method 200, the one or more hardware processors are configured to jointly train (or update) the initialized plurality of dictionaries and the associated plurality of sparse coefficients using the plurality of training images by performing steps 206A and 206B iteratively until convergence of an objective function is achieved. The objective function is given by equation 4. Convergence of the objective function is achieved when the loss given by equation 4 does not change significantly over the subsequent iterations, with the absolute value being less than an empirically calculated threshold value. The trained plurality of dictionaries and the associated plurality of sparse coefficients obtained upon achieving the convergence of the objective function are used for performing a multimodal image super resolution.

$${min}_{S , G , A , B , W , V} \frac{1}{2} {‖ X - SA ‖}_{F}^{2} + \frac{1}{2} {‖ Y - GB ‖}_{F}^{2} + \frac{μ}{2} {‖ Z - WA - VB ‖}_{F}^{2} + {λ}_{a} {‖ A ‖}_{1} + {λ}_{b} {‖ B ‖}_{1} \qquad ( 4 )$$

The equation 4 is derived from equation 5 by using block structured notations for dictionaries, coefficients as defined in equation 2 and considering Sₘ, Gₘ, Vₘ, Wₘ as linear operators such that Sₘa_{m,i}=Sₘ*a_{m,i}, Gₘb_{m,i}=gₘ*b_{m,i}, Wₘa_{m,i}=Wₘ*a_{m,i} and Vₘb_{m,i}=vₘ*b_{m,i}.

$${min}_{\{ {s}_{m} \} , \{ {g}_{m} \} , \{ {a}_{m , i} \} , \{ {b}_{m , i} \} . \{ {w}_{m} \} , \{ {v}_{m} \}} \frac{1}{2} {\sum }_{i} {‖ {x}_{i} - {\sum }_{m} {s}_{m} * {a}_{m , i} ‖}_{2}^{2} + \frac{1}{2} {\sum }_{i} {‖ {y}_{i} - {\sum }_{m} {g}_{m} * {b}_{m , i} ‖}_{2}^{2} + \frac{μ}{2} {\sum }_{i} {‖ {z}_{i} - {\sum }_{m} {w}_{m} * {a}_{m , i} - {\sum }_{m} {v}_{m} * {b}_{m , i} ‖}_{2}^{2} + {λ}_{a} {\sum }_{i , m} {‖ {a}_{m , i} ‖}_{1} + {λ}_{b} {\sum }_{i , m} {‖ {b}_{m , i} ‖}_{1} subject to {‖ {s}_{m} ‖}_{2}^{2} = 1 , {‖ {g}_{m} ‖}_{2}^{2} = 1 , {‖ {w}_{m} ‖}_{2}^{2} = 1 , {‖ {v}_{m} ‖}_{2}^{2} = 1 \qquad ( 5 )$$

The first two terms in equations 4 and 5 ensure that each of the dictionary filters and coefficients are learnt in such a way that they reconstruct the images of respective modality well. The third term defines coupling between coefficients of different image modalities to reconstruct the HR image of target modality. The remaining terms constrain the learned coefficients to be sparse.

At step 206A, the plurality of sparse coefficients are trained (alternatively referred as learnt or updated) by keeping the plurality of dictionaries fixed. The first set of sparse coefficients are updated based on the set of LR images of the target modality, the set of HR images of the target modality, the first convolutional dictionary, the first coupling convolutional dictionary, the second coupling convolutional dictionary, and the second set of sparse coefficients by solving equation 6 using Alternating Direction Method of Multipliers (ADMM) technique. The second set of sparse coefficients are updated based on the set of HR images of guidance modality, the set of HR images of the target modality, the second convolutional dictionary, the first coupling convolutional dictionary, the second coupling convolutional dictionary, and the first set of sparse coefficients by solving equation 7 using ADMM technique.

$${min}_{A} \frac{1}{2} {‖ X - SA ‖}_{F}^{2} + \frac{μ}{2} {‖ {X}^{′} - WA ‖}_{F}^{2} + {λ}_{a} {‖ A ‖}_{1} , wherein {X}^{′} = Z - VB \qquad ( 6 )$$

$${min}_{B} \frac{1}{2} {‖ Y - GB ‖}_{F}^{2} + \frac{μ}{2} {‖ {Y}^{′} - VB ‖}_{F}^{2} + {λ}_{b} {‖ B ‖}_{1} , wherein {Y}^{′} = Z - WA \qquad ( 7 )$$

Applying ADMM to equation 6 using variable splitting by introducing an auxiliary variable Pₐ constrained to be equal to the primary variable A results in equation 8.

$${min}_{A , {P}_{a}} \frac{1}{2} {‖ X - SA ‖}_{F}^{2} + \frac{μ}{2} {‖ {X}^{′} - WA ‖}_{F}^{2} + {λ}_{a} {‖ {P}_{a} ‖}_{1} subject to A = {P}_{a} \qquad ( 8 )$$

With Uₐ as dual variable, the ADMM iterations are given by equations 9 to 11, where p controls convergence rate.

$${A}^{t + 1} = {min}_{A} \frac{1}{2} ‖ X - SA ‖ + \frac{μ}{2} {‖ {X}^{′} - WA ‖}_{F}^{2} + \frac{ρ}{2} {‖ A - {P}_{a}^{t} + {U}_{a}^{t} ‖}_{F}^{2} \qquad ( 9 )$$

$${P}_{a}^{t + 1} = {min}_{{P}_{a}} \frac{ρ}{2} {‖ {A}^{t + 1} - {P}_{a} + {U}_{a}^{t} ‖}_{F}^{2} + {λ}_{a} {‖ {P}_{a} ‖}_{1} \qquad ( 10 )$$

$${U}_{a}^{t + 1} = {U}_{a}^{t} + {A}^{t + 1} - {P}_{a}^{t + 1} \qquad ( 11 )$$

Taking Qₐ=Pₐ^{t}−Uₐ^{t}, the solution of A is obtained by taking derivative of equation 9 with respect to A and equating it to zero which results in equation 12.

$$( {S}^{H} S + μ {W}^{H} W + ρ I ) A = {S}^{H} X + μ {W}^{H} {X}^{′} + ρ \qquad ( 12 )$$

Applying Discrete Fourier Transform (DFT) to equation 12 results in equation 13 where \hat{ } indicates DFT transform of respective parameters.

$$( {\hat{S}}^{H} \hat{S} + μ {\overline{W}}^{H} \overline{W} + ρ I ) = {\hat{S}}^{H} \hat{X} + μ {\overline{W}}^{H} {\hat{X}}^{′} + ρ \qquad ( 13 )$$

The solution to equation 13 is obtained using iterated Sherman-Morrison algorithm. The solution to equation 10 is obtained by soft-thresholding similar to the work in [Fangyuan Gao et. al., “Multi-modal convolutional dictionary learning,” IEEE Transactions on Image Processing, vol. 31, pp. 1325-1339, 2022] and equation 11 is solved by simple arithmetic operations. Similarly, solution to equation 7 is given by equation 14, where Q_{b}=P_{b}^{t}−U_{b}^{t}.

$$( {\hat{G}}^{H} \hat{G} + μ {\hat{V}}^{H} \hat{V} + ρ I ) \hat{B} = {\hat{G}}^{H} \hat{Y} + μ {\hat{V}}^{H} {\hat{Y}}^{′} + ρ \qquad ( 14 )$$

The auxiliary variable P_{b} and dual variable U_{b} associated with the second set of coefficients B follow standard updates similar to equations 10 and 11.

Once the plurality of sparse coefficients are updated, at step 206B, the plurality of dictionaries are trained by keeping the plurality of sparse coefficients fixed. The first convolutional dictionary is updated based on the set of LR images of the target modality using Convolutional Constrained Method of Optimal Directions (CCMOD) technique. The second convolutional dictionary is updated based on the set of HR images of the guidance modality using the CCMOD technique. The first coupling convolutional dictionary is updated based on the set of HR images of the target modality, the first set of sparse coefficients, the second set of sparse coefficients and the second coupling convolutional dictionary by converting into a standard Convolutional Dictionary Learning (CDL) problem by minimizing ½∥X′−WA∥₂², wherein X′=Z−VB. Similarly, the second coupling convolutional dictionary is updated based on the set of HR images of the target modality, the first set of sparse coefficients, the second set of sparse coefficients and the first coupling convolutional dictionary by converting into a standard CDL problem by minimizing ½∥Y′−VB∥₂², wherein Y′=Z−WA. The plurality of dictionaries obtained after training are used to perform MISR.

FIGS. 5A to 5D, collectively referred as FIG. 5, illustrate examples of trained plurality of dictionaries obtained from method of FIG. 2, according to some embodiments of the present disclosure. FIG. 5A illustrates first convolutional dictionary {sₘ}ₘ₌₁ that is trained to extract features from images of the target modality (Multispectral (MS) images in this example). FIG. 5B illustrates second convolutional dictionary {gₘ}ₘ₌₁ that is trained to extract features from images of the guidance modality (RGB (Red, Green, Blue) images in this example). FIGS. 5C and 5D illustrates first coupling convolutional dictionary {wₘ}ₘ₌₁ and second coupling convolutional dictionary {vₘ}ₘ₌₁, respectively, that are trained to model relationship between target and guidance modalities. FIG. 5 illustrates each of the trained plurality of dictionaries employing different numbers of filters M=4, 8 and 12 of atom size k=8×8 on RGB-MS data. Low-Resolution MS images are known to be dominated by low-frequency components, resulting in a smoothed dictionary sₘ emphasizing low frequencies for the LR target modality. On the other hand, High-Resolution guidance modality (RGB) images contain both high and low-frequency components, that enables the learned filters gₘ to accommodate a wider frequency range. A high correlation between gₘ and wₘ, as well as between sₘ and corresponding vₘ can be observed from FIGS. 5A, 5C and FIGS. 5B, 5D respectively. This correlation arises from the shared set of sparse codes (coefficients) aₘ and bₘ, respectively. Also, it can be observed that the learned coupling convolutional dictionaries effectively combine the high frequency information from HR guidance and low frequency information from LR target to synthesize the HR target image.

The plurality of dictionaries obtained upon achieving the convergence of the objective function are used for performing multimodal image super resolution on a new low resolution image X^{test} of the target modality by using a HR image Y^{test} of the guidance modality. Initially a first set of test coefficients A^{test} is computed based on the learned first convolutional dictionary S and the LR image of the target modality X^{test} following a standard convolutional sparse coding update by solving equation 15.

$${min}_{{A}^{test}} \frac{1}{2} {‖ {X}^{test} - S {A}^{test} ‖}_{F}^{2} + {λ}_{a} {A}^{test} \qquad ( 15 )$$

Similarly, a second set of test coefficients B^{test} is computed based on the learned second convolutional dictionary G and the HR image of the guidance modality Y^{test} following the standard convolutional sparse coding update by solving equation 16.

$${min}_{{B}^{test}} \frac{1}{2} {‖ {Y}^{test} - G {B}^{test} ‖}_{F}^{2} + {λ}_{b} {B}^{test} \qquad ( 16 )$$

Finally, a high resolution image Z^{test} of the target modality is generated using the learned first coupling convolutional dictionary W, the second coupling convolutional dictionary V, the first set of test coefficients, and the second set of test coefficients as Z^{test}=WA^{test}+VB^{test}.
FIG. 3 is a block diagram of an example implementation of method of FIG. 2, according to some embodiments of the present disclosure. Images of a scene in the target modality (MS) and guidance modality (RGB) are obtained. Then, a first set of coefficients A and a second set of coefficients B are computed using the trained first convolutional dictionary S (illustrated in FIG. 5A) and the second convolutional dictionary G (illustrated in FIG. 5B), respectively. Finally, a high resolution image of target modality is generated using the computed first set of coefficients A, a second set of coefficients B, trained first coupling convolutional dictionary (illustrated in FIG. 5C) and trained second coupling convolutional dictionary (illustrated in FIG. 5D).

### Experimental Results

Data Description: Datasets used for evaluating the performance of the method 200 are: (1) RGB-Multispectral dataset [Ayan Chakrabarti and Todd Zickler, “Statistics of real-world hyperspectral images,” in CVPR 2011. IEEE, 2011, pp. 193-200.] and (2) RGB-NIR dataset [Matthew Brown and Sabine Susstrunk, “Multi-spectral sift for scene category recognition,” in CVPR 2011. IEEE, 2011, pp. 177-184.]. In both the datasets, RGB image is considered as the guidance modality. Multispectral image is considered as the target modality in the first dataset and NIR (Near InfraRed) image is considered as the target modality in the second dataset. The two datasets contain the HR images of both the guidance (Y) and target modalities (Z). For experimentation purpose, LR image of target modality is generated by downsizing the HR image by a required factor and then applying bicubic interpolation on the down sampled image to upscale by the same factor. A factor of 4 is considered for down sampling both RGB/Multispectral and RGB/NIR for a fair comparison with benchmark techniques. Here, the RGB image used as guidance modality is converted to grayscale. Also, the multispectral image at 640 nm is considered in the experiments for the RGB-Multispectral dataset.

Benchmark Methods: The method 200 is compared with eight state-of-the-art MISR techniques including:
1) Guided image Filtering (GF [Kaiming He, Jian Sun, and Xiaoou Tang, “Guided image filtering,” IEEE transactions on pattern analysis and machine intelligence, vol. 35, pp. 1397-1409, 06 2013]),
2) Joint Bilateral Filtering (JBF [Johannes Kopf, Michael F Cohen, Dani Lischinski, and Matt Uyttendaele, “Joint bilateral upsampling,” ACM Transactions on Graphics (ToG), vol. 26, no. 3, pp. 96-es, 2007.]),
3) Joint image Restoration (JR [Xiaoyong Shen, Qiong Yan, Li Xu, Lizhuang Ma, and Jiaya Jia, “Multispectral joint image restoration via optimizing a scale map,” IEEE transactions on pattern analysis and machine intelligence, vol. 37, no. 12, pp. 2518-2530, 2015]),
4) Deep Joint image Filtering (DJF [Yijun Li, Jia-Bin Huang, Narendra Ahuja, and Ming-Hsuan Yang, “Deep joint image filtering,” in European Conference on Computer Vision. Springer, 2016, pp. 154-169]),
5) Coupled Dictionary Learning (Coupled DL [Pingfan Song, Xin Deng, Joao F C Mota, Nikos Deligiannis, Pier Luigi Dragotti, and Miguel RD Rodrigues, “Multimodal image super-resolution via joint sparse representations induced by coupled dictionaries,” IEEE Transactions on Computational Imaging, vol. 6, pp. 57-72, 2019.]),
6) shallow variant of Joint Coupled Transform Learning (JCTL [Andrew Gigie, A Anil Kumar, Angshul Majumdar, Kriti Kumar, and M Girish Chandra, “Joint coupled transform learning framework for multimodal image super-resolution,” in ICASSP 2021-2021 IEEE International Conference on Acoustics, Speech and Signal Processing (ICASSP). IEEE, 2021, pp. 1640-1644.]),
7) Joint Coupled Deep Transform Learning (JCDTL [R Krishna Kanth, Andrew Gigie, Kriti Kumar, A Anil Kumar, Angshul Majumdar, and Balamuralidhar P, “Multi-modal image super-resolution with joint coupled deep transform learning,” in 2022 30th European Signal Processing Conference (EUSIPCO), 2022, pp. 474-478.]), and
8) Multi-modal Convolutional Dictionary Learning (MCDL [Fangyuan Gao, Xin Deng, Mai Xu, Jingyi Xu, and Pier Luigi Dragotti, “Multi-modal convolutional dictionary learning,” IEEE Transactions on Image Processing, vol. 31, pp. 1325-1339, 2022]).

Results: The reconstruction quality of the HR image of the target modality is assessed using Structural SIMilarity (SSIM) and Peak Signal to Noise Ratio (PSNR) metrics. The benchmark methods are trained on 31 image pairs for RGB/NIR and 35 image pairs for RGB/Multispectral. Each 512×512 image is divided into non-overlapping patches of size 16×16. During testing, the patches of the test image are reconstructed individually and combined to create the full image. On the other hand, the techniques using convolutional dictionary learning (method 200 and MCDL) consider non-overlapping patches of size 256×256 for training, and testing is conducted on the full image. The method 200 is trained only on 10 image pairs for each dataset instead of 31 and 35 image pairs, respectively, considered for benchmark methods. The hyperparameters associated with all the techniques are tuned using grid search. The method 200 is implemented using the SPORCO library in MATLAB. The results for method 200 and MCDL are reported using 4 filters of size 8×8 that gave optimal performance for both the datasets.

TABLE 1
RGB/NIR Dataset (4x up sampling)

Test

| image | Indoor 4 | | Indoor 5 | | Indoor 11 | | Indoor 16 | | Indoor 21 | |
|---|---|---|---|---|---|---|---|---|---|---|
| Method | PSNR | SSIM | PSNR | SSIM | PSNR | SSIM | PSNR | SSIM | PSNR | SSIM |
| Method | 31.423 | 0.925 | 32.263 | 0.933 | 31.387 | 0.908 | 32.128 | 0.930 | 31.257 | 0.911 |
| 200 | | | | | | | | | | |
| MCDL | 28.932 | 0.902 | 28.307 | 0.908 | 28.874 | 0.842 | 30.601 | 0.914 | 28.787 | 0.865 |
| JCDTL | 28.783 | 0.899 | 30.414 | 0.915 | 30.384 | 0.903 | 32.018 | 0.916 | 29.442 | 0.893 |
| JCTL | 27.961 | 0.915 | 30.580 | 0.937 | 26.808 | 0.893 | 30.438 | 0.925 | 26.554 | 0.895 |
| Coupled | 30.629 | 0.942 | 29.865 | 0.951 | 28.879 | 0.896 | 33.070 | 0.950 | 29.668 | 0.915 |
| DL | | | | | | | | | | |
| DJF | 26.958 | 0.898 | 27.804 | 0.899 | 27.015 | 0.817 | 30.149 | 0.890 | 27.619 | 0.853 |
| JR | 22.271 | 0.841 | 25.076 | 0.939 | 22.864 | 0.815 | 23.502 | 0.867 | 21.626 | 0.794 |
| GF | 29.854 | 0.946 | 32.058 | 0.971 | 27.589 | 0.901 | 31.916 | 0.938 | 27.133 | 0.909 |
| JBF | 26.354 | 0.919 | 31.283 | 0.968 | 26.480 | 0.906 | 30.431 | 0.929 | 25.746 | 0.902 |

TABLE 2
RGB/Multispectral Dataset (4x up sampling)

Test

| image | Imge6 | | Imge7 | | Imgf5 | | Imgf7 | | Imgh3 | |
|---|---|---|---|---|---|---|---|---|---|---|
| Method | PSNR | SSIM | PSNR | SSIM | PSNR | SSIM | PSNR | SSIM | PSNR | SSIM |
| Method | 31.779 | 0.856 | 36.732 | 0.928 | 38.984 | 0.954 | 34.830 | 0.907 | 40.361 | 0.961 |
| 200 | | | | | | | | | | |
| MCDL | 25.477 | 0.605 | 28.955 | 0.709 | 33.426 | 0.880 | 27.894 | 0.722 | 35.564 | 0.896 |
| JCDTL | 31.441 | 0.841 | 35.496 | 0.899 | 37.522 | 0.947 | 33.339 | 0.888 | 39.403 | 0.948 |
| JCTL | 28.793 | 0.814 | 32.669 | 0.889 | 36.277 | 0.939 | 31.964 | 0.864 | 37.140 | 0.941 |
| Coupled | 31.049 | 0.835 | 33.222 | 0.877 | 34.239 | 0.906 | 31.401 | 0.878 | 36.107 | 0.920 |
| DL | | | | | | | | | | |
| DJF | 20.968 | 0.828 | 26.732 | 0.938 | 32.588 | 0.824 | 23.851 | 0.902 | 30.788 | 0.924 |
| JR | 26.519 | 0.814 | 32.781 | 0.889 | 33.933 | 0.890 | 29.295 | 0.804 | 33.999 | 0.922 |
| GF | 25.332 | 0.774 | 29.709 | 0.869 | 31.706 | 0.901 | 28.045 | 0.880 | 33.518 | 0.807 |
| JBF | 25.535 | 0.746 | 29.655 | 0.799 | 32.411 | 0.886 | 28.874 | 0.839 | 34.461 | 0.902 |

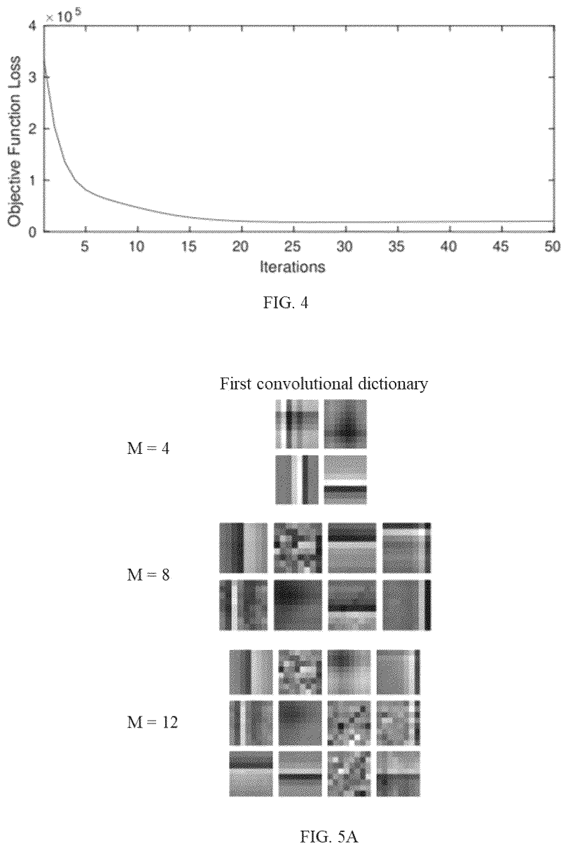

Tables 1 and 2 summarize the MISR results for the first and second datasets, respectively, obtained with 5 test image pairs. It can be observed that the joint learning-based approaches (Coupled DL, JCTL, JCDTL, and the method 200) display superior performance compared to other filtering (DJF, JR, GF, and JBF) and two-stage (MCDL) based approaches for most of the images. This is because joint learning enables effective learning of discriminative and common features or representations from each modality (LR image of target and HR image of guidance) that assists in improved reconstruction of HR image of target modality. Among the joint learning methods, the method 200 shows improved reconstruction compared to other benchmark methods for most of the images, despite training with limited data. This demonstrates the potential of using shift-invariant dictionaries, i.e., convolutional dictionaries, in learning representation for robust and effective modelling for MISR. It is important to note that compared to the two-stage CDL-based MCDL approach that requires learning 6 convolutional dictionaries and 3 associated sparse coefficients (1 common and 2 unique for the respective modality), method 200 requires learning only 4 convolutional dictionaries and 2 associated sparse coefficients. Thus, even with reduced complexity, the disclosed method provides improved performance over the MCDL approach as shown in tables 1 and 2. The convergence plot of the method 200 is given in FIG. 4, which shows that the method converges within a few iterations. The method 200 took approximately 10 minutes for training over 10 image pairs with 50 iterations and approximately 0.9 seconds for testing on one image pair on AMD Ryzen 5 4500U CPU@2.3 GHz with 16 GB RAM without GPU. In contrast, the existing deep learning methods, like DJF, require approximately 2 hours to train and 2 seconds for testing, despite using a GPU accelerator.

The written description describes the subject matter herein to enable any person skilled in the art to make and use the embodiments. The scope of the subject matter embodiments is defined by the claims and may include other modifications that occur to those skilled in the art. Such other modifications are intended to be within the scope of the claims if they have similar elements that do not differ from the literal language of the claims or if they include equivalent elements with insubstantial differences from the literal language of the claims.

It is to be understood that the scope of the protection is extended to such a program and in addition to a computer-readable means having a message therein; such computer-readable storage means contain program-code means for implementation of one or more steps of the method, when the program runs on a server or mobile device or any suitable programmable device. The hardware device can be any kind of device which can be programmed including e.g., any kind of computer like a server or a personal computer, or the like, or any combination thereof. The device may also include means which could be e.g., hardware means like e.g., an application-specific integrated circuit (ASIC), a field-programmable gate array (FPGA), or a combination of hardware and software means, e.g., an ASIC and an FPGA, or at least one microprocessor and at least one memory with software processing components located therein. Thus, the means can include both hardware means and software means. The method embodiments described herein could be implemented in hardware and software. The device may also include software means. Alternatively, the embodiments may be implemented on different hardware devices, e.g., using a plurality of CPUs.

The embodiments herein can comprise hardware and software elements. The embodiments that are implemented in software include but are not limited to, firmware, resident software, microcode, etc. The functions performed by various components described herein may be implemented in other components or combinations of other components. For the purposes of this description, a computer-usable or computer readable medium can be any apparatus that can comprise, store, communicate, propagate, or transport the program for use by or in connection with the instruction execution system, apparatus, or device.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope of disclosed embodiments being indicated by the following claims.

What is claimed is:

1. A processor implemented method, comprising:
obtaining, via one or more hardware processors, a plurality of training images further comprising a set of low-resolution images ‘X’ of a target modality, a set of high-resolution images ‘Y’ of a guidance modality, and a set of high-resolution images ‘Z’ of the target modality;
initializing, via the one or more hardware processors, a plurality of dictionaries and associated plurality of sparse coefficients, wherein the plurality of dictionaries comprise i) a first convolutional dictionary ‘S’ associated with a first set of sparse coefficients ‘A’ among the plurality of sparse coefficients, ii) a second convolutional dictionary ‘G’ associated with a second set of sparse coefficients ‘B’ among the plurality of sparse coefficients, iii) a first coupling convolutional dictionary ‘W’, and iv) a second coupling convolutional dictionary ‘V’; and
jointly training, via the one or more hardware processors, the initialized plurality of dictionaries and the associated plurality of sparse coefficients using the plurality of training images by performing a plurality of steps iteratively until convergence of an objective function is achieved, wherein the trained plurality of dictionaries and the associated plurality of sparse coefficients obtained upon achieving the convergence of the objective function are used for performing a multimodal image super resolution, and wherein the plurality of steps comprise:
training the plurality of sparse coefficients by keeping the plurality of dictionaries fixed; and
training the plurality of dictionaries by keeping the plurality of sparse coefficients fixed.

2. The method of claim 1, wherein the objective function is represented as:
$${min}_{S , G , A , B , W , V} \frac{1}{2} {‖ X - SA ‖}_{F}^{2} + \frac{1}{2} {‖ Y - GB ‖}_{F}^{2} + \frac{μ}{2} {‖ Z - W A - VB ‖}_{F}^{2} + {λ}_{a} {‖ A ‖}_{1} + {λ}_{b} {‖ B ‖}_{1} .$$

3. The method of claim 1, wherein training the plurality of sparse coefficients by keeping the plurality of dictionaries fixed comprises:
updating the first set of sparse coefficients based on the set of low-resolution images of the target modality, the set of high-resolution images of the target modality, the first convolutional dictionary, the first coupling convolutional dictionary, the second coupling convolutional dictionary, and the second set of sparse coefficients by solving
$${min}_{A} \frac{1}{2} {‖ X - SA ‖}_{F}^{2} + \frac{μ}{2} {‖ {X}^{′} - WA ‖}_{F}^{2} + {λ}_{a} {‖ A ‖}_{1} ,$$
wherein X′=Z−VB; and
updating the second set of sparse coefficients based on the set of high-resolution images of guidance modality, the set of high-resolution images of the target modality, the second convolutional dictionary, the first coupling convolutional dictionary, the second coupling convolutional dictionary, and the first set of sparse coefficients by solving
$${min}_{B} \frac{1}{2} {‖ Y - GB ‖}_{F}^{2} + \frac{μ}{2} {‖ {Y}^{′} - VB ‖}_{F}^{2} + {λ}_{b} {‖ B ‖}_{1} ,$$
wherein Y′=Z−WA.

4. The method of claim 1, wherein training the plurality of dictionaries by keeping the plurality of sparse coefficients fixed comprises:
updating the first convolutional dictionary based on the set of low-resolution images of the target modality;
updating the second convolutional dictionary based on the set of high-resolution images of the guidance modality;
updating the first coupling convolutional dictionary based on the set of high-resolution images of the target modality, the first set of sparse coefficients, the second set of sparse coefficients and the second coupling convolutional dictionary by converting into a standard Convolutional Dictionary Learning (CDL) problem; and
updating the second coupling convolutional dictionary based on the set of high-resolution images of the target modality, the first set of sparse coefficients, the second set of sparse coefficients and the first coupling convolutional dictionary by converting into a standard CDL problem.

5. The method of claim 4, wherein converting the first coupling convolutional dictionary into a standard CDL problem comprises minimizing ½∥X′−WA∥₂², wherein X′=Z−VB, and wherein converting the second coupling convolutional dictionary into a standard CDL problem comprises minimizing ½∥Y′−VB∥₂², wherein Y′=Z−WA.

6. The method of claim 1, comprising performing multimodal image super resolution on a new low resolution image of the target modality by:
obtaining the new low-resolution image X^{test} of the target modality and a high-resolution image Y^{test} of the guidance modality;
computing a first set of test coefficients A^{test} based on the trained first convolutional dictionary S and the low-resolution image of the target modality X^{test} by using a standard convolutional sparse coding update;
computing a second set of test coefficients B^{test} based on the trained second convolutional dictionary G and the high-resolution image of the guidance modality Y^{test} by using the standard convolutional sparse coding update; and
generating a high resolution image Z^{test} of the target modality using the trained first coupling convolutional dictionary, the trained second coupling convolutional dictionary, the first set of test coefficients, and the second set of test coefficients as Z^{test}=WA^{test}+VB^{test}.

7. A system comprising:
a memory storing instructions;
one or more communication interfaces; and
one or more hardware processors coupled to the memory via the one or more communication interfaces, wherein the one or more hardware processors are configured by the instructions to:
obtain a plurality of training images comprising a set of low-resolution images ‘X’ of a target modality, a set of high-resolution images ‘Y’ of a guidance modality, and a set of high-resolution images ‘Z’ of the target modality;
initialize a plurality of dictionaries and associated plurality of sparse coefficients, wherein the plurality of dictionaries comprise i) a first convolutional dictionary ‘S’ associated with a first set of sparse coefficients ‘A’ among the plurality of sparse coefficients, ii) a second convolutional dictionary ‘G’ associated with a second set of sparse coefficients ‘B’ among the plurality of sparse coefficients, iii) a first coupling convolutional dictionary ‘W’, and iv) a second coupling convolutional dictionary ‘V’; and
jointly train the initialized plurality of dictionaries and the associated plurality of sparse coefficients using the plurality of training images by performing a plurality of steps iteratively until convergence of an objective function is achieved, wherein the trained plurality of dictionaries and the associated plurality of sparse coefficients obtained upon achieving the convergence of the objective function are used for performing a multimodal image super resolution, and wherein the plurality of steps comprise:
training the plurality of sparse coefficients by keeping the plurality of dictionaries fixed; and
training the plurality of dictionaries by keeping the plurality of sparse coefficients fixed.

8. The system of claim 7, wherein the objective function is represented as:
$${min}_{S , G , A , B , W , V} \frac{1}{2} {‖ X - SA ‖}_{F}^{2} + \frac{1}{2} {‖ Y - GB ‖}_{F}^{2} + \frac{μ}{2} {‖ Z - W A - VB ‖}_{F}^{2} + {λ}_{a} {‖ A ‖}_{1} + {λ}_{b} {‖ B ‖}_{1} .$$

9. The system of claim 7, wherein training the plurality of sparse coefficients by keeping the plurality of dictionaries fixed comprises:
updating the first set of sparse coefficients based on the set of low-resolution images of the target modality, the set of high-resolution images of the target modality, the first convolutional dictionary, the first coupling convolutional dictionary, the second coupling convolutional dictionary, and the second set of sparse coefficients by solving
$${min}_{A} \frac{1}{2} {‖ X - SA ‖}_{F}^{2} + \frac{μ}{2} {‖ {X}^{′} - WA ‖}_{F}^{2} + {λ}_{a} {‖ A ‖}_{1} ,$$
wherein X′=Z−VB; and
updating the second set of sparse coefficients based on the set of high-resolution images of guidance modality, the set of high-resolution images of the target modality, the second convolutional dictionary, the first coupling convolutional dictionary, the second coupling convolutional dictionary, and the first set of sparse coefficients by solving
$${min}_{B} \frac{1}{2} {‖ Y - GB ‖}_{F}^{2} + \frac{μ}{2} {‖ {Y}^{′} - VB ‖}_{F}^{2} + {λ}_{b} {‖ B ‖}_{1} ,$$
wherein Y′=Z−WA.

10. The system of claim 7, wherein training the plurality of dictionaries by keeping the plurality of sparse coefficients fixed comprises:
updating the first convolutional dictionary based on the set of low-resolution images of the target modality;
updating the second convolutional dictionary based on the set of high-resolution images of the guidance modality;
updating the first coupling convolutional dictionary based on the set of high-resolution images of the target modality, the first set of sparse coefficients, the second set of sparse coefficients and the second coupling convolutional dictionary by converting into a standard Convolutional Dictionary Learning (CDL) problem; and
updating the second coupling convolutional dictionary based on the set of high-resolution images of the target modality, the first set of sparse coefficients, the second set of sparse coefficients and the first coupling convolutional dictionary by converting into a standard CDL problem.

11. The system of claim 10, wherein converting the first coupling convolutional dictionary into a standard CDL problem comprises minimizing ½∥X′−WA∥₂², wherein X′=Z−VB, and wherein converting the second coupling convolutional dictionary into a standard CDL problem comprises minimizing ½∥Y′−VB∥₂², wherein Y′=Z−WA.

12. The system of claim 7, comprising performing multimodal image super resolution on a new low resolution image of the target modality by:
obtaining the new low-resolution image X^{test} of the target modality and a high-resolution image Y^{test} of the guidance modality;
computing a first set of test coefficients A^{test} based on the trained first convolutional dictionary S and the low-resolution image of the target modality X^{test} by using a standard convolutional sparse coding update;
computing a second set of test coefficients B^{test} based on the trained second convolutional dictionary G and the high-resolution image of the guidance modality Y^{test} by using the standard convolutional sparse coding update; and
generating a high resolution image Z^{test} of the target modality using the trained first coupling convolutional dictionary, the trained second coupling convolutional dictionary, the first set of test coefficients, and the second set of test coefficients as Z^{test}=WA+VB.

13. One or more non-transitory machine-readable information storage mediums comprising one or more instructions which when executed by one or more hardware processors cause:
obtaining a plurality of training images comprising a set of low-resolution images ‘X’ of a target modality, a set of high-resolution images ‘Y’ of a guidance modality, and a set of high-resolution images ‘Z’ of the target modality;
initializing a plurality of dictionaries and associated plurality of sparse coefficients, wherein the plurality of dictionaries comprise i) a first convolutional dictionary ‘S’ associated with a first set of sparse coefficients ‘A’ among the plurality of sparse coefficients, ii) a second convolutional dictionary ‘G’ associated with a second set of sparse coefficients ‘B’ among the plurality of sparse coefficients, iii) a first coupling convolutional dictionary ‘W’, and iv) a second coupling convolutional dictionary ‘V’; and
jointly training the initialized plurality of dictionaries and the associated plurality of sparse coefficients using the plurality of training images by performing a plurality of steps iteratively until convergence of an objective function is achieved, wherein the trained plurality of dictionaries and the associated plurality of sparse coefficients obtained upon achieving the convergence of the objective function are used for performing a multimodal image super resolution, and wherein the plurality of steps comprise:
training the plurality of sparse coefficients by keeping the plurality of dictionaries fixed; and
training the plurality of dictionaries by keeping the plurality of sparse coefficients fixed.

14. The one or more non-transitory machine-readable information storage mediums of claim 13, wherein the objective function is represented as:
$${min}_{S , G , A , B , W , V} \frac{1}{2} {‖ X - SA ‖}_{F}^{2} + \frac{1}{2} {‖ Y - GB ‖}_{F}^{2} + \frac{μ}{2} {‖ Z - W A - VB ‖}_{F}^{2} + {λ}_{a} {‖ A ‖}_{1} + {λ}_{b} {‖ B ‖}_{1} .$$

15. The one or more non-transitory machine-readable information storage mediums of claim 13, wherein training the plurality of sparse coefficients by keeping the plurality of dictionaries fixed comprises:
updating the first set of sparse coefficients based on the set of low-resolution images of the target modality, the set of high-resolution images of the target modality, the first convolutional dictionary, the first coupling convolutional dictionary, the second coupling convolutional dictionary, and the second set of sparse coefficients by solving
$${min}_{A} \frac{1}{2} {‖ X - SA ‖}_{F}^{2} + \frac{μ}{2} {‖ {X}^{′} - WA ‖}_{F}^{2} + {λ}_{a} {‖ A ‖}_{1} ,$$
wherein X′=Z−VB; and
updating the second set of sparse coefficients based on the set of high-resolution images of guidance modality, the set of high-resolution images of the target modality, the second convolutional dictionary, the first coupling convolutional dictionary, the second coupling convolutional dictionary, and the first set of sparse coefficients by solving
$${min}_{B} \frac{1}{2} {‖ Y - GB ‖}_{F}^{2} + \frac{μ}{2} {‖ {Y}^{′} - VB ‖}_{F}^{2} + {λ}_{b} {‖ B ‖}_{1} ,$$
wherein Y′=Z−WA.

16. The one or more non-transitory machine-readable information storage mediums of claim 13, wherein training the plurality of dictionaries by keeping the plurality of sparse coefficients fixed comprises:
updating the first convolutional dictionary based on the set of low-resolution images of the target modality;
updating the second convolutional dictionary based on the set of high-resolution images of the guidance modality;
updating the first coupling convolutional dictionary based on the set of high-resolution images of the target modality, the first set of sparse coefficients, the second set of sparse coefficients and the second coupling convolutional dictionary by converting into a standard Convolutional Dictionary Learning (CDL) problem; and
updating the second coupling convolutional dictionary based on the set of high-resolution images of the target modality, the first set of sparse coefficients, the second set of sparse coefficients and the first coupling convolutional dictionary by converting into a standard CDL problem.

17. The one or more non-transitory machine-readable information storage mediums of claim 16, wherein converting the first coupling convolutional dictionary into a standard CDL problem comprises minimizing ½∥X′−WA∥₂², wherein X′=Z−VB, and wherein converting the second coupling convolutional dictionary into a standard CDL problem comprises minimizing ½∥Y′−VB∥₂², wherein Y′=Z−WA.

18. The one or more non-transitory machine-readable information storage mediums of claim 13, wherein the one or more instructions which when executed by the one or more hardware processors cause performing multimodal image super resolution on a new low resolution image of the target modality by:
obtaining the new low-resolution image X^{test} of the target modality and a high-resolution image Y^{test} of the guidance modality;
computing a first set of test coefficients A^{test} based on the trained first convolutional dictionary S and the low-resolution image of the target modality X^{test} by using a standard convolutional sparse coding update;
computing a second set of test coefficients B^{test} based on the trained second convolutional dictionary G and the high-resolution image of the guidance modality Y^{test} by using the standard convolutional sparse coding update; and
generating a high resolution image Z^{test} of the target modality using the trained first coupling convolutional dictionary, the trained second coupling convolutional dictionary, the first set of test coefficients, and the second set of test coefficients as Z^{test}=WA^{test}+VB^{test}.
